(19) United States
(12) Patent Application Publication
(10) Pub. No.: US 2026/0254855 A1
(43) Pub. Date: Aug. 27, 2026

(54) POLICY ENFORCEMENT ASSISTANT

(71) Applicant: Cisco Technology, Inc., San Jose, CA (US)

(72) Inventors: Prashanth Arun, San Jose, CA (US); Sameer Somalwar Reddy, Brooklyn, NY (US); Arjun Sambamoorthy, San Jose, CA (US); Anand Raghavan, Santa Clara, CA (US)

(21) Appl. No.: 19/171,158

(22) Filed: Apr. 4, 2025

Related U.S. Application Data
(60) Provisional application No. 63/761,111, filed on Feb. 20, 2025.

(51) Int. Cl. H04L 9/40; H04L 41/16

(52) U.S. Cl. CPC H04L 63/20; H04L 41/16; H04L 63/1416

(57) ABSTRACT

A policy enforcement assistant is provided to assist in identifying and implementing configuration changes within a network. The policy enforcement assistant can receive inputs such as administrator inputs, and can determine intent indications based on the inputs, wherein the intent indications indicate configuration change intents affecting the network. The policy enforcement assistant can identify, based on an intent indication, multiple configuration changes under an applicable network policy. The policy enforcement assistant can furthermore identify implementation paths for each of the configuration changes. The implementation paths can use different network management tools to implement the configuration changes. The policy enforcement assistant can either execute the configuration changes via the implementation paths or instruct a user regarding executing the configuration changes.

### RELATED APPLICATIONS

This application claims priority to U.S. Provisional Patent Application No. 63/761,111 filed on Feb. 20, 2025, the entire contents of which are incorporated herein by reference for all purposes.

### TECHNICAL FIELD

The present disclosure relates generally to management and security of computer networks, and to tools for managing computer networks in particular.

### BACKGROUND

Networking technology companies such as CISCO® and others offer many different network management tools to their customers, and the customers often run multiple network management tools concurrently in their enterprise networks. Example network management tools include, e.g., Cisco Secure Access, Cisco Duo, various Cisco firewall products, Cisco Meraki, and others. Customers may run several or all of these tools concurrently, optionally along with other tools, to manage different aspects of their enterprise networks.

The customers may use network management tools to operate their enterprise networks according to network policies, which can include security policies as well as other network polices. The customers may have information technology (IT) departments responsible for making configuration changes in the enterprise networks to implement and enforce their network policies as circumstances change.

Example circumstances that may change can include, for example, users may enter and leave a company, or users may change roles within the company. New devices and software may be added, removed, physically moved, and/or reconfigured. Security threats may be discovered and require actions such as quarantining or blocking access to some or all network resources.

Currently, when IT departments make configuration changes according to their network policies, they generally to make use of each of their company’s network management tools. This may entail first attaining a level of control at which the changes can be implemented, followed by implementing the changes themselves.

For example, a network policy may require an IT department to restrict employee access to a particular application or website. To accomplish this, the IT department may access multiple different network management tools, and implement controls at different network elements. Each network element can provide a different avenue or channel through which a user could access the application or website, and so each network element may need to be reconfigured in order to implement the policy. This process can be cumbersome and time-consuming and can also lead to attack vectors if IT departments forget to use one or more of their network management tools to change configurations in one or more network elements.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture comprising various devices in a network, the network including network management device(s) equipped with a policy enforcement assistant and network management tools, in accordance with various aspects of the technologies disclosed herein.

FIG. 2 illustrates an example policy enforcement assistant and operations thereof, in accordance with various aspects of the technologies disclosed herein.

FIG. 3 illustrates example network management tools comprising multiple functions, and an example implementation path to use the functions of the network management tools to effect a network configuration change, in accordance with various aspects of the technologies disclosed herein.

FIG. 4 illustrates an example packet switching system that can be utilized to implement devices in accordance with various aspects of the technologies disclosed herein.

FIG. 5 illustrates an example node that can be utilized to implement devices in accordance with various aspects of the technologies disclosed herein.

FIG. 6 illustrates an example computer hardware architecture that can implement devices in accordance with various aspects of the technologies disclosed herein.

FIG. 7 is a flow diagram that illustrates an example method involving a policy enforcement assistant, in accordance with various aspects of the technologies disclosed herein.

### DESCRIPTION OF EXAMPLE EMBODIMENTS

This disclosure describes techniques that can be performed in connection with operating a policy enforcement assistant. Example techniques can include determining an intent indication based on an input, e.g., an administrator input, identifying, based on the intent indication, multiple configuration changes applicable to the network under a policy associated with the network, and identifying a respective implementation path for each respective network configuration change of the multiple configuration changes. The respective implementation path can comprise a respective series of interactions with a respective network management tool, to implement the respective network configuration change. At least two different implementation paths can use at least two different network management tools. Example techniques can further include generating an output comprising the respective implementation path for each respective network configuration change.

The techniques described herein may be performed by one or more computing devices comprising one or more processors and one or more computer-readable media storing computer-executable instructions that, when executed by the one or more processors, cause the one or more processors to perform the methods disclosed herein. The techniques described herein may also be accomplished using non-transitory computer-readable media storing computer-executable instructions that, when executed by one or more processors, perform the methods carried out by the network controller device.

### EXAMPLE EMBODIMENTS

In an example according to this disclosure, a policy enforcement assistant is provided to assist in identifying and implementing configuration changes applicable to a network. The policy enforcement assistant can be configured to receive intent indications based on inputs, such as administrator inputs. The policy enforcement assistant can identify, based on an intent indication, multiple configuration changes under an applicable network policy. The policy enforcement assistant can furthermore be configured to identify implementation paths for each of the configuration changes. The implementation paths can use different network management tools to implement the configuration changes. The policy enforcement assistant can either execute the configuration changes via the implementation paths on the network management tools, or it can instruct a user regarding executing the configuration changes.

In some embodiments, the policy enforcement assistant described herein can suggest configuration changes across multiple network management tool products to remediate a situation corresponding to a network security posture or security policy. Networking companies offer many different network management tool products to their enterprise network customers, and the customers often run multiple of these network management tool products in their enterprise networks.

As described in the above background section, when enterprise network customers make configuration changes in accordance with a network policy, their IT department employees generally access each of their network management tool products and follow appropriate security procedures to attain a level of control at which the configuration changes can be implemented. For example, an IT department may wish to restrict employee access to a particular application or website. To accomplish this, the IT department may access multiple network management tool products (e.g., Secure Access, DUO, Firewall, Meraki, etc.) and implement configuration changes at different levels/layers/devices their enterprise network. The different levels/layers/devices in the enterprise network provide different avenues or channels through which a user could access the restricted application or website, all of which may be addressed in order to enforce the restriction. Not only are such processes cumbersome and time-consuming, but they can also lead to attack vectors if an IT department forgets to change network configurations in one of the network management tool products.

One example use case of the policy enforcement assistant provided herein can address a potential account compromise in an enterprise network. An enterprise network user may be found to be behaving suspiciously, leading to a conclusion that the user’s account may have been compromised. An IT department can address this situation based on the enterprise network’s defined security posture/policy as configured.

As a practical matter, addressing an account compromise may involve performing operations via two different network management tools: an endpoint agent tool such as Cisco Secure Access, and a firewall management tool such as Cisco Firewall. Each of these network management tools can be used to block a user from accessing corporate applications, until the issue is resolved.

The policy enforcement assistant described herein can be applied to identify, based on an input indicating the account compromise, the network management tools to be used as well as sequences of operations to be followed in each of the network management tools. Such sequences of operations are referred to herein as “implementation paths.” The policy enforcement assistant can output instructions regarding performing the implementation paths or can effect the implementation paths in whole or in part through automated interactions with the identified network management tools.

Another example use case of the policy enforcement assistant provided herein can address a malware detection. A network security service may detect a potential malware infection, triggering automatic protections based on a configured security posture/policy.

As a practical matter, addressing the malware detection can involve performing operations via multiple different network management tools: a first firewall management tool such as a first Cisco Firewall tool can be used to update rules to block command and control (C&C) traffic on a firewall, a second firewall management tool such as a second Cisco Firewall tool can be used to block domain name server (DNS) host lookups on new C&C domains, and an endpoint agent tool such as Cisco Secure Access can be used to update rules on endpoints to look for specific malware executables.

The policy enforcement assistant described herein can be applied to identify, based on an input indicating the malware detection, the network management tools to be used as well as the implementation paths to be followed in each of the network management tools. As described above, the policy enforcement assistant can output instructions regarding performing the implementation paths or can effect the implementation paths in whole or in part through automated interactions with the identified network management tools.

The policy enforcement assistant described herein can be configured to access data defining network management tools and their functions / capabilities. Furthermore, the policy enforcement assistant can access network topology data including the devices and their relationships and functions within an enterprise network. The policy enforcement assistant can also access updated network policy data that defines policies for an enterprise network and which may change over time. The terms “policy” “network policy” as used herein encompass any policies that may be applied in a network environment, e.g., security policies, access policies, device policies, user policies, network policies, etc. Based on these data sources, the policy enforcement assistant can be configured to identify configuration changes to be applied in response to different input intents such as setting up new users, implementing user role changes, configuring new devices, configuring new applications and services, etc.

In one aspect, the policy enforcement assistant can be configured to identify an administrator intent based on a spoken or typed input. The input may be, e.g., “restrict a user from quarterly report information.” Based on such an input, the policy enforcement assistant can be configured to identify the intent of blocking a user from any possibility of accessing certain sensitive databases. Other example intents may be, e.g., to add a user, delete a user, conduct a user role change, block a user from accessing certain devices or functions, add or subtract devices and services, etc.

Once translated, the policy enforcement assistant can apply the administrator intent to an entire network, and each layer of the network, optionally concurrently. For example, there are multiple network management tools that provide access control at different layers of a network, such as Secure Access, DUO, Firewall, and Meraki. The policy enforcement assistant can identify overlapping functionality between the different network management tools and provide administrators with a unified mechanism to manage the overlapping functionality for all of these network management tools from one location.

In the example of restricting a user from accessing an application or website, the policy enforcement assistant can be configured to determine configuration changes at one or more different layers of a network, and the network management tools, and the policy enforcement assistant can optionally map overlapping capabilities of the network management tools. The policy enforcement assistant can then determine and/or perform remediations across all the identified network management tools, for example by restricting access to an application or website across all the different access layers of the network.

In some examples, an administrator can interact with the policy enforcement assistant described herein using a simple text-based conversation window, which may be backed by a large language model (LLM). The administrator can request for example that the policy enforcement assistant, “please block User A from accessing this social media website.” The policy enforcement assistant can interpret an intent based on the input, identify the network management tools with overlapping functionality required to implement the intent, and provide the administrator with a list of operations to use the network management tools in order to achieve the intent of blocking user access. For instance, the LLM based system can be configured to reply to the administrator and instruct them to carry out several different implementation paths to (1) add a rule into a firewall, (2) add a rule into Meraki, and so forth. The administrator can approve of the recommended course of action, and the policy enforcement assistant can optionally automatically apply the configuration changes across the identified and potentially overlapping network management tools.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

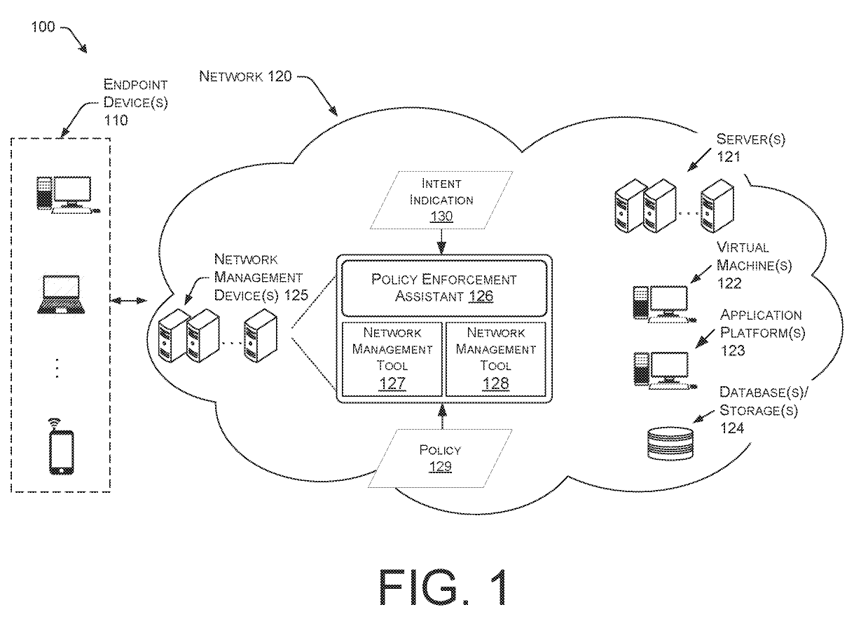

FIG. 1 illustrates an example architecture 100 comprising various devices in a network 120, the network 120 including network management device(s) 125 equipped with a policy enforcement assistant 126 and network management tools 127, 128, in accordance with various aspects of the technologies disclosed herein. FIG. 1 comprises endpoint device(s) 110 and the network 120. The network 120 can include server(s) 121, virtual machine(s) 122, application platform(s) 123, database(s)/storage(s) 124, and the network management device(s) 125. The network management device(s) 125 can comprise the policy enforcement assistant 126. Alternatively, the policy enforcement assistant 126 can be implemented at any devices in the network 120 or in the endpoint device(s) 110.

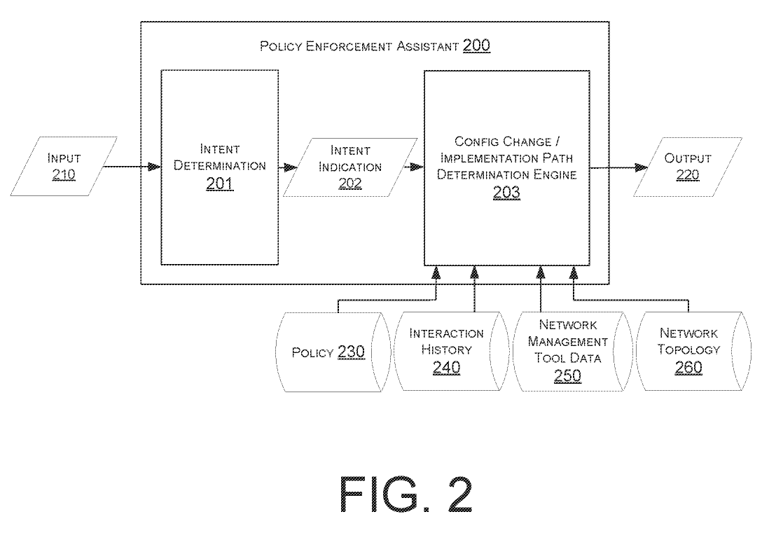

The policy enforcement assistant 126 can optionally be implemented as one or more trained machine learning (ML) or artificial intelligence (AI) modules, as described further in connection with FIG. 2. In some examples, the policy enforcement assistant 126 can receive an input ion the form of a natural language input from an administrator, including, e.g., a text or voice input, and can determine an intent indication 130 based on the input. The intent indication 130 can indicate an intent, such as the addition of a new user or device, a role change, a security or other network event, or otherwise, to which a network policy, e.g., policy 129 may be applied. In some examples, the intent indication 130 can be supplied to the policy enforcement assistant 126 by an administrator, eliminating the need for determining the intent indication 130 by the policy enforcement assistant 126.

The policy enforcement assistant 126 can optionally consult the policy 129 to determine, based on the intent indication 130, any configuration changes required within the network 120 based on the policy 129. Some embodiments may consult the policy 129 directly, e.g., via a policy database or policy lookup table comprising intent indications and corresponding configuration changes. Other embodiments may use a trained ML model which can identify configuration changes based on interaction history data that describes historic interactions between administrators and the network management tools 127, 128. The interaction history can comprise previous intent indications, corresponding interactions between administrators and the network management tools 127, 128, and corresponding resulting configuration changes.

The policy enforcement assistant 126 can be configured to determine which network management tools 127, 128 to use to produce identified configuration changes within the network 120, as well as implementation paths for each of the identified network management tools 127, 128 to produce the desired configuration changes. In some embodiments, the policy enforcement assistant 126 can be configured to use various data sources such as the policy 129, network topology data, data defining the functions of the network management tools 127, 128, and/or interaction history data, to identify network management tools 127, 128 and corresponding implementation paths.

The policy enforcement assistant 126 can be configured to produce, for each intent indication 130, an output comprising identified network management tools 127, 128 and implementation paths for each of the network management tools 127, 128 to produce identified configuration changes required under the policy 129 in response to the intent indication. In some examples, the output can comprise text or other visual instructions for an administrator, instructing the administrator in the use of the network management tools 127, 128. In other examples, the output can comprise an approval or disapproval control, and the policy enforcement assistant 126 can be configured to apply the output in response to approval thereof. In still further examples, the output can comprise one or more automated interactions between the policy enforcement assistant 126 and the network management tools 127, 128, without necessarily requiring administrator approval.

In further aspects of FIG. 1, the one or more endpoint device(s) 110 can optionally be inside of the network 120, or otherwise can access, through one or more other networks, a variety of resources located in the network 120. The network management device(s) 125 can provide network management and security functions for devices in the network 120 as well as for endpoint device(s) 110, such as an intrusion detection or prevention system (IDS/IPS), denial-of-service (DoS) attack protection, session monitoring, and other security services. Network 120 can comprise an enterprise network operated by a business, university, government agency or other entity.

In various examples, the endpoint device(s) 110 can comprise any devices that can connect to the network 120, either wirelessly or via direct cable connections. For example, the endpoint device(s) 110 may include but are not limited to mobile telephones, personal digital assistants (PDAs), media players, tablet computers, gaming devices, smart watches, hotspots, personal computers (PCs) such as laptops, desktops, or workstations, or any other type of computing or communication device. In other examples, the endpoint device(s) 110 may comprise vehicle-based devices, wearable devices, wearable materials, virtual reality (VR) devices, smart watches, smart glasses, clothes made of smart fabric, etc. The endpoint device(s) 110 can optionally connect to the network 120 via multiple different networks, including e.g., home networks, public networks, private networks, virtual private networks, etc. The network management device(s) 125 can be configured to control all aspects and permissions affecting the connections between the endpoint device(s) 110 and the other elements of the network 120. The network management device(s) 125 can optionally implement a policy enforcement controller which enforces network policies via multiple different policy enforcement points distributed among the other devices of the network 120.

In various examples, the network 120 can be a public cloud, a private cloud, or a hybrid cloud and may host a variety of resources such as one or more server(s) 121, one or more virtual machine(s) 122, one or more application platform(s) 123, one or more database(s)/storage(s) 124, etc. The server(s) 121 may include the pooled and centralized server resources related to application content, storage, and/or processing power. The server(s) 121 may provide virtual private network (VPN) functions that can optionally be managed by the network management device(s) 125. The application platform(s) 123 may include one or more cloud environments for designing, building, deploying and managing custom business applications. Virtual desktop(s) may image operating systems and applications of a physical device, e.g., any of endpoint device(s) 110, and allow users to access their desktops and applications from anywhere on any kind of endpoint devices. The database(s)/storage(s) 124 may include one or more of file storage, block storage or object storage.

It should be understood that the one or more server(s) 121, one or more virtual machine(s) 122, one or more application platform(s) 123, and one or more database(s)/storage(s) 124 illustrate multiple functions, available services, and available resources provided by the network 120. Although shown as individual network participants in FIG. 1, the server(s) 121, the virtual machine(s) 122, the application platform(s) 123, and the database(s)/storage(s) 124 can be integrated and deployed on one or more computing devices and/or servers in the network 120.

In implementations, the network 120 can comprise any types of firewalls. Example firewalls include a packet filtering firewall that operates inline at junction points of network devices such as routers and switches. A packet filtering firewall can compare each packet received to a set of established criteria, such as the allowed IP addresses, packet type, port number and other aspects of the packet protocol headers. Packets that are flagged as suspicious are dropped and not forwarded. Example firewalls may further include a circuit-level gateway that monitors transmission control protocol (TCP) handshakes and other network protocol session initiation messages across the network to determine whether the session being initiated is legitimate. Example firewalls may further include an application-level gateway (also referred to as a proxy firewall) that filters packets not only according to the service as specified by the destination port but also according to other characteristics, such as the hypertext transfer protocol (HTTP) request string. Yet another example firewall may be a stateful inspection firewall that monitors an entire session for a state of a connection, while also checking internet protocol (IP) addresses and payloads for more thorough security. A next-generation firewall, as another example firewall, can combine packet inspection with stateful inspection and can also include some variety of deep packet inspection (DPI), as well as other network security systems, such as IDS/IPS, malware filtering and antivirus functions.

In various examples, the illustrated elements of the network 120 can be deployed as one or more hardware-based appliances, software-based appliances, and/or cloud-based services. A hardware-based appliance may also be referred to as network-based appliance or network-based firewall. The hardware-based appliance can act as a secure gateway between the network 120 and the endpoint device(s) 110 and can protect the devices/storages inside the perimeter of the network 120 from being attacked by malicious actors.

The illustrated elements of the network 120 can be arranged in different logical layers and can optionally be configured according to many different network configuration settings to carry out a desired policy 129. The network management device(s) 125 can optionally communicate with any of the illustrated elements to modify settings thereof in order to modify network 120 configuration.

FIG. 2 illustrates an example policy enforcement assistant 200 and operations thereof, in accordance with various aspects of the technologies disclosed herein. The policy enforcement assistant 200 can implement the policy enforcement assistant 126 in some examples. The policy enforcement assistant 200 comprises intent determination 201, intent indication 202, and configuration change / implementation path determination engine 203. FIG. 2 further comprises an input 210 supplied to the policy enforcement assistant 200 and an output 220 generated by the policy enforcement assistant 200, as well as example data sources including policy 230, interaction history 240, network management tool data 250, and network topology 260.

In example operations of the policy enforcement assistant 200 illustrated in FIG. 2, the policy enforcement assistant 200 can receive an input 210, e.g., from an administrator or network security function. The input 210 may indicate any of a variety of circumstances that should trigger a network configuration change, according to a policy 230. For example, the input 210 may indicate a user change such as new user, user role change, or user termination. The input 210 may indicate an application, service, or device change such as new application, service, or device, change of an application, service, or device, or removal of an application, service, or device. The input 210 may indicate a security event such as detected suspicious user behavior or detected potential malware. The input 210 can comprise, e.g., a natural language input such as a text input or voice input. The input 210 can also comprise event data from a security system, or for example an application programming interface (API) input.

The input 210 can initially be processed by intent determination 201 in order to identify an intent indication 202 corresponding to the input 210. The input 210 may potentially be ambiguous, and even if not ambiguous, the input 210 may not straightforwardly identify an intent to which the policy 230 can be applied. Intent determination 201 can be configured to translate the input 210 into an intent indication 202 of a type that is addressable by the policy 230. For example, an input 210 such as “John Doe was promoted to Vice President,” can be translated into an intent indication 202 which specifies a user role change and corresponding changes to the user’s resource access privileges.

In an example implementation, intent determination 201 can be implemented as a trained LLM type machine learning module. Intent determination 201 can be trained on training data comprising historical user inputs and corresponding identified network events that trigger configuration changes. In an alternative or additional aspect, intent determination 201 can be implemented can be configured to supply one or more dialogs to gather any needed input information, which can be used to determine the intent indication 202. A draft intent indication 202 can optionally be presented to an administrator for approval.

The configuration change / implementation path determination engine 203 can be configured to use the intent indication 202 to determine one or more configuration changes to reconfigure a network and/or elements thereof in response to the intent indication 202, as may be required under the policy 230. Configuration changes can include, e.g., network configuration changes, security configuration changes, access configuration changes, device or user configuration changes, policy configuration changes, database configuration changes, application configuration changes, firewall configuration changes, endpoint access configuration changes, endpoint device configuration changes, or otherwise. The configuration change / implementation path determination engine 203 can furthermore be configured to use the intent indication 202 to determine one or more implementation paths to use available network management tools to make identified configuration changes.

In some examples, the configuration change / implementation path determination engine 203 can be configured to look up the intent indication 202 in policy data such as policy 230, in order to identify configuration changes associated with the intent indication 202. The configuration change / implementation path determination engine 203 can then look up any identified configuration changes in network management tool data 250, in order to identify network management tools for use in making the configuration changes, as well as implementation path information for using of identified network management tools to make the configuration changes. The configuration change / implementation path determination engine 203 can include identified implementation path information as output 220.

In other examples, the configuration change / implementation path determination engine 203 can comprise a trained machine learning module that is configured to identify network management tool implementation paths based on intent indication 202. The trained machine learning module can be trained for example using interaction history 240, network management tool data 250, and/or network topology 260 as training data. The interaction history 240 can comprise previous intent indications and corresponding interactions between administrators and network management tools, resulting in configuration changes. A set of corresponding interactions between an administrator and a network management tool can represent an implementation path to produce a network configuration change. The network management tool data 250 can comprise data representing available network management tools, their various functions, and the configuration changes they are capable of producing. The network topology 260 can represent network applications and devices and relationship therebetween.

In embodiments wherein the configuration change / implementation path determination engine 203 comprises a trained machine learning module, the configuration change / implementation path determination engine 203 need not necessarily identify configuration changes prior to identifying network management tool implementation paths. Instead, the configuration change / implementation path determination engine 203 may solve implementation path identification directly based on the intent indication 202. The resulting configuration changes, resulting from identified implementation paths, need not necessarily be identified by the configuration change / implementation path determination engine 203.

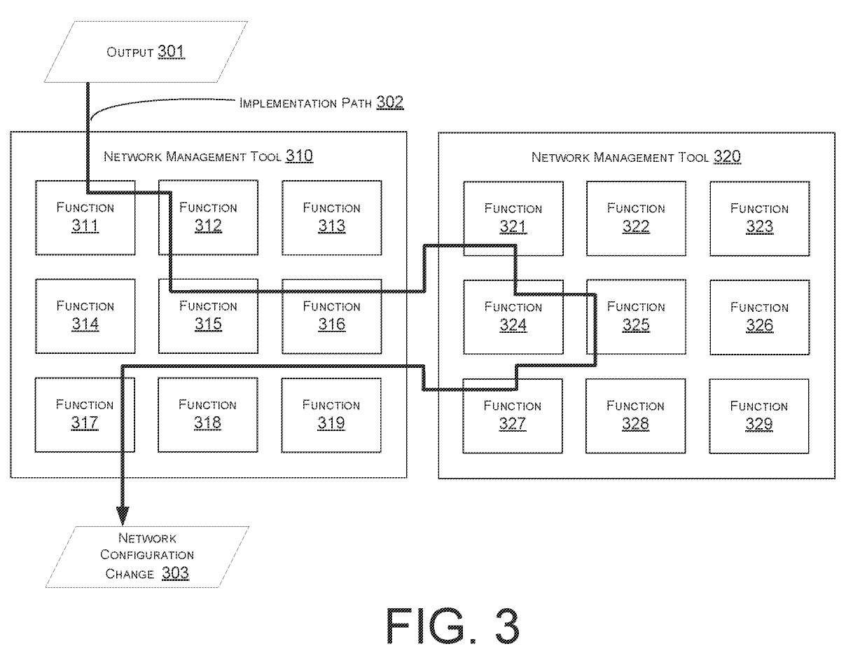

In some examples, the output 220 can optionally comprise a text or graphic display including instructions for an administrator to carry out any implementation paths via interfaces provided by network management tools. An example implementation path is illustrated in FIG. 3. In other examples, the output 220 can optionally comprise implementation path descriptions administrator approval, and the policy enforcement assistant 200 can be configured to interact with network management tools to conduct the implementation paths upon approval thereof. In still further examples, the output 220 can optionally comprise one or more automated interactions with one or more network management tools, according to identified implementation paths and without necessarily obtaining advance approval thereof.

FIG. 3 illustrates example network management tools 310, 320 comprising multiple functions, and an example implementation path 302 to use the functions of the network management tools 310, 320 to effect a network configuration change 303, in accordance with various aspects of the technologies disclosed herein. The network management tool 310 comprises example functions 311, 312, 313, 314, 315, 316, 317, 318, and 319, and the network management tool 320 comprises example functions 321, 322, 323, 324, 325, 326, 327, 328, and 329. The network management tools 310, 320 can implement, e.g., either of the network management tools 127, 128 illustrated in FIG. 1, or any network management tools for which the policy enforcement assistant 200 illustrated in FIG. 2 can generate an implementation path 302.

The network management tools 310, 320 can comprise any tools equipped to modify network configuration settings, whether such settings are at endpoint devices, VPN management applications or devices, firewall applications or devices, or otherwise. The network management tools 310, 320 can comprise, e.g., tools to configure secure clients installed on endpoint devices of a network such as Cisco Secure Access, a tool to configure user authentication functions of the network such as Cisco Duo, a tool to configure one or more firewalls of the network such as Cisco firewall; or a tool to configure Wi-Fi access points of the network such as Cisco Meraki.

The network management tools 310, 320 can provide any number of buttons, dialogs, user interface elements, selectable menu elements and the like. The functions 311-319 and 321-329 represent any functions of any network management tools. In some cases, one or more second functions may be conditional on an output of a first function and may be accessible after the first function is employed.

The output 301 can comprise implementation path information, such as instructions regarding a subset of the functions 301-309, 321-329 to be used, a sequence for using the subset of the functions, and optionally data to input into one or more functions, in order to produce the network configuration change 303. The implementation path 302 can comprise a set of interactions with the network management tools 310, 320 according to the output 301. In the illustrated example, the implementation path 302 comprises an interaction with the function 311, followed by an interaction with the function 312, followed by an interaction with the function 315, followed by an interaction with the function 316, followed by an interaction with the function 321, followed by an interaction with the function 324, followed by an interaction with the function 325, followed by an interaction with the function 327, followed by an interaction with the function 317. The illustrated implementation path 302 is an example only and any implementation path through the functions of the network management tools 310, 320, or additional network management tools, are possible, including those that repeat interactions with certain functions.

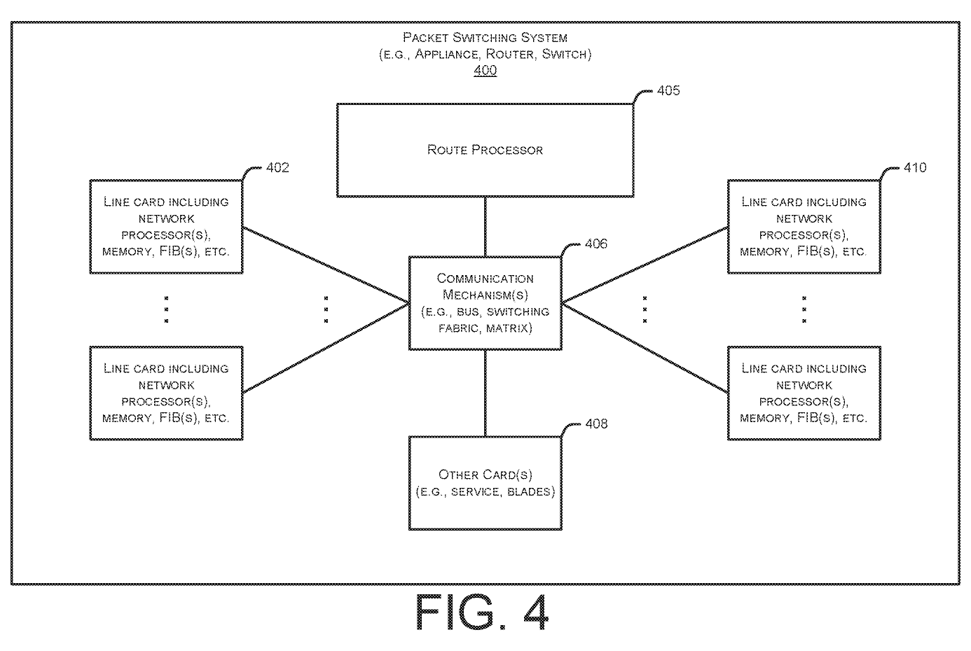

FIG. 4 illustrates an example packet switching system 400 that can be utilized to implement devices of a network in accordance with various aspects of the technologies disclosed herein. In some examples, the packet switching system 400 can comprise a device that may be configured according to configuration changes such as the example network configuration change 303 illustrated in FIG. 3. In some examples, the packet switching system 400 can be implemented as one or more packet switching device(s). The packet switching system 400 may be employed in a network, for example, the packet switching system 400 can implement a router configured to process network traffic by receiving and forwarding packets.

In some examples, the packet switching system 400 may comprise multiple line card(s) 402, 410, each with one or more network interfaces for sending and receiving packets over communications links (e.g., possibly part of a link aggregation group). The packet switching system 400 may also have a control plane with one or more processing elements, e.g., the route processor 405 for managing the control plane and/or control plane processing of packets associated with forwarding of packets in a network. The packet switching system 400 may also include other cards 408 (e.g., service cards, blades) which include processing elements that are used to process (e.g., forward/send, drop, manipulate, change, modify, receive, create, duplicate, apply a service) packets associated with forwarding of packets in a network.

The packet switching system 400 may comprise a communication mechanism 406 (e.g., bus, switching fabric, and/or matrix, etc.) for allowing the different entities such as the multiple line card(s) 402, 410, the route processor 405, and the other cards 408 to communicate. The communication mechanism 406 can optionally be hardware-based. Line card(s) 402, 410 may perform the actions of being both an ingress and/or an egress line card of the line card(s) 402, 410, with regard to multiple packets and/or packet streams being received by, or sent from, the packet switching system 400.

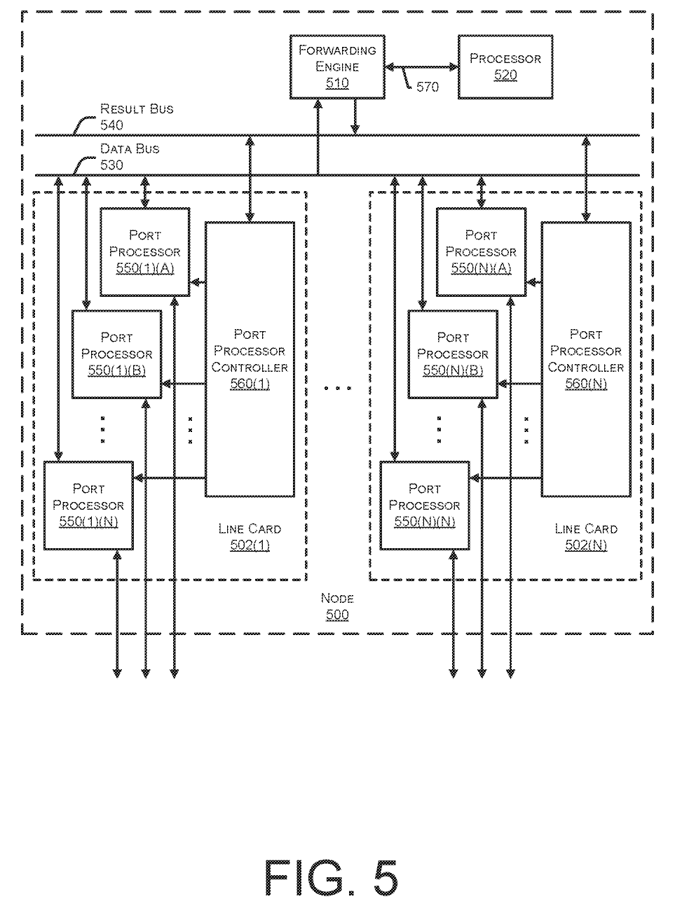

FIG. 5 illustrates an example node that can be utilized to implement devices in accordance with various aspects of the technologies disclosed herein. For example, the node 500 can implement a device that may be configured according to configuration changes such as the example network configuration change 303 illustrated in FIG. 3. In some examples, node 500 may include any number of line cards, e.g., line cards 502(1)- 502(N), where N may be any integer greater than 1, and wherein the line cards are communicatively coupled to a forwarding engine 510 (also referred to herein as an encryption engine) and/or a processor 520 via a data bus 530 and/or a result bus 540.

Line cards may include any number of port processors, for example, line card 502(1) comprises port processors 550(1)(A) - 550(1)(N), and line card 502(N) comprises port processors 550(N)(A) - 550(N)(N). The port processors can be controlled by port processor controllers, e.g., port processor controllers 560(1), 560(N), respectively.

Additionally, or alternatively, the forwarding engine 510 and/or the processor 520 can be coupled to one another via the data bus 530 and the result bus 540 and may also be communicatively coupled to one another by a communications link 570. The processors (e.g., the port processor(s) 550(1)(A) - 550(1)(N) and 550(N)(A) - 550(N)(N), and/or the port processor controller(s) 560(1), 560(N)) of each line card 502(1), 502(N) may optionally be mounted on a single printed circuit board.

When a packet or packet and header are received, the packet or packet and header may be identified and analyzed by the node 500 in the following manner. Upon receipt, a packet (or some or all of its control information) or packet and header may be sent from one of port processor(s) at which the packet or packet and header was received and to one or more of those devices coupled to the data bus 530 (e.g., others of the port processor(s), the forwarding engine 510 and/or the processor 520). Handling of the packet or packet and header may be determined, for example, by the forwarding engine 510.

For example, the forwarding engine 510 may determine that the packet or packet and header should be forwarded to one or more of the other port processors. This may be accomplished by indicating to corresponding one(s) of port processor controllers that a copy of the packet or packet and header held in the given one(s) of port processor(s) should be forwarded to the appropriate other one of port processor(s). Additionally, or alternatively, once a packet or packet and header has been identified for processing, the forwarding engine 510, the processor 520, and/or the like may be used to process the packet or packet and header in some manner and/or may add packet security information in order to secure the packet.

On a node 500 sourcing a packet or packet and header, processing may include, for example, encryption of some or all of the packet or packet and header information, the addition of a digital signature, and/or some other information and/or processing capable of securing the packet or packet and header. On a node 500 receiving a packet or packet and header, the processing may be performed to recover or validate the packet or packet and header information that has been secured.

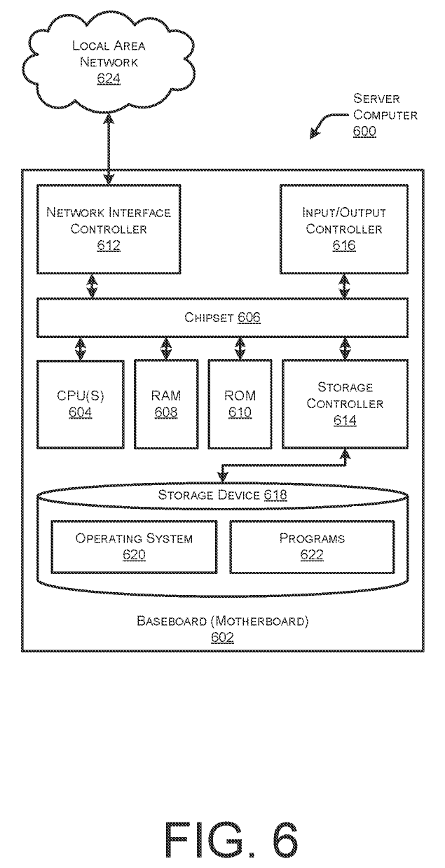

FIG. 6 illustrates an example computer hardware architecture that can implement devices in accordance with various aspects of the technologies disclosed herein. For example, the illustrated computer hardware architecture can implement a network management device 125 which may provide a console for accessing a policy enforcement assistant 126 as well as network management tools 127, 128, or any of the other network devices described herein in some embodiments. The computer architecture shown in FIG. 6 illustrates a conventional server computer 600, however the computer architecture can optionally implement any other computing devices such as a router, a workstation, desktop computer, laptop, tablet, network appliance, e-reader, smartphone, or other computing device. The illustrated computer architecture can be utilized to execute any of the software components presented herein.

The server computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the server computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the server computer 600. The chipset 606 can further provide an interface to a computer-readable storage medium such as a read-only memory (“ROM”) 610 or non-volatile RAM (“NVRAM”) for storing basic routines that help to start up the server computer 600 and to transfer information between the various components and devices. The ROM 610 or NVRAM can also store other software components necessary for the operation of the server computer 600 in accordance with the configurations described herein.

The server computer 600 can operate in a networked environment using logical connections to remote computing devices and computer systems through a network, such as the LAN 624. The chipset 606 can include functionality for providing network connectivity through a NIC 612, such as a gigabit Ethernet adapter. The NIC 612 is capable of connecting the server computer 600 to other computing devices over the LAN 624. It should be appreciated that multiple NICs 612 can be present in the server computer 600, connecting the computer to other types of networks and remote computer systems.

The server computer 600 can be connected to a storage device 618 that provides non-volatile storage for the server computer 600. The storage device 618 can store an operating system 620, programs 622, and data, to implement any of the various components described in detail herein.

The storage device 618 can be connected to the server computer 600 through a storage controller 614 connected to the chipset 606. The storage device 618 can comprise one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the server computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 600 can further read information from the storage device 618 by detecting the physical states or characteristics of one or more particular locations within the physical storage units.

In addition to the mass storage device 618 described above, the server computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 600. In some examples, the operations performed by the computing elements illustrated in FIGS. 1-3, 7, and or any components included therein, may be supported by one or more devices similar to server computer 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the server computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the server computer 600.

In one embodiment, the storage device 618 or other computer-readable storage media is encoded with computer-executable instructions which, when loaded into the server computer 600, transform the computer from a general-purpose computing system into a special-purpose computer capable of implementing the embodiments described herein. These computer-executable instructions transform the server computer 600 by specifying how the CPUs 604 transition between states, as described above.

According to one embodiment, the server computer 600 has access to computer-readable storage media storing computer-executable instructions which, when executed by the server computer 600, can implement the architectures and perform the various processes described with regard to FIGS. 1-3 and 7. The server computer 600 can also include computer-readable storage media having instructions stored thereupon for performing any of the other computer-implemented operations described herein.

The server computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat panel display, a digital projector, a printer, or other type of output device. It will be appreciated that the server computer 600 might not include all of the components shown in FIG. 6, can include other components that are not explicitly shown in FIG. 6, or might utilize an architecture completely different than that shown in FIG. 6.

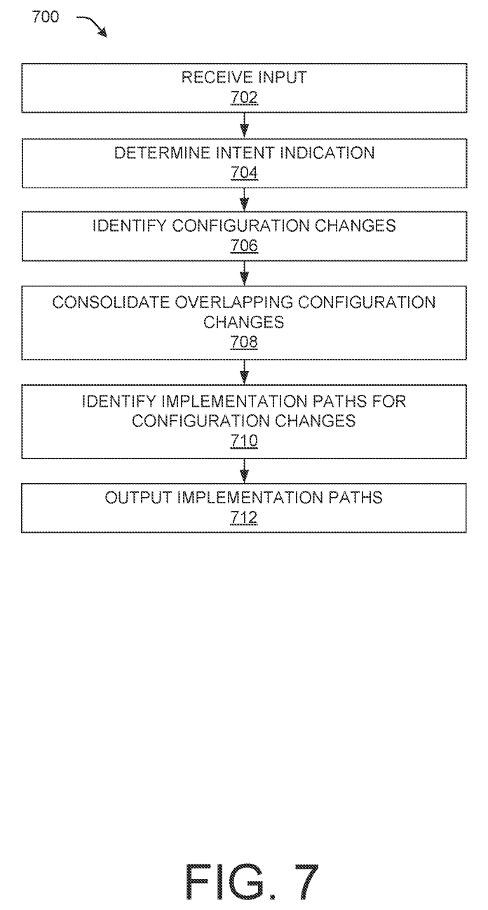

FIG. 7 is a flow diagram of an example method 700 performed at least partly by a computing device, such as the server computer 600, optionally in conjunction with other computing devices. The logical operations described herein with respect to FIG. 7 may be implemented (1) as a sequence of computer-implemented acts or program modules running on a computing system and/or (2) as interconnected machine logic circuits or circuit modules within the computing system. In some examples, the method 700 may be performed by a system comprising one or more processors and one or more non-transitory computer-readable media storing computer-executable instructions that, when executed by the one or more processors, cause the one or more processors to perform the method 700.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof.

It should also be appreciated that more or fewer operations might be performed than shown in FIG. 7 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 7 is a flow diagram that illustrates an example method involving a policy enforcement assistant, in accordance with various aspects of the technologies disclosed herein. In an example embodiment, the illustrated method can be performed by a server such as illustrated in FIG. 6, or by a network management device 125 comprising a policy enforcement assistant 126, as shown in FIG. 1. The policy enforcement assistant 126 can be implemented as illustrated in FIG. 2, and the network management device 125 can further implement, e.g., a combined network management console equipped with access to the policy enforcement assistant 126 as well as the example network management tools 127, 128.

At operation 702, a policy enforcement assistant 200 can be configured to receive an input 210. At operation 704, the policy enforcement assistant 200 can be configured to apply intent determination 201 to the input 210 determine an intent indication 202 based on the input 210. Intent determination 201 may be configured as an LLM type ML module, or otherwise, as described herein.

The intent indication 202 can correspond to an event which triggers a configuration change, or a desired configuration change (also referred to herein as a configuration change intent) in a network 120. For example, the intent indication 202 can correspond to desired configuration change such as a user change, a device change, a service change, or a security threat.

At operation 706, the policy enforcement assistant 200 can be configured to identify, based on the intent indication 202, multiple configuration changes applicable to the network 120 under a policy 129 associated with the network 120. The policy 129 can be implemented as the policy 230 illustrated in FIG. 2. The multiple configuration changes can comprise, e.g., configuration changes to block or restrict a user of the network 120, configuration changes to block or restrict a device connected to the network 120, configuration changes to block or restrict a service of the network 120, or configuration changes to block or restrict a security threat of the network 120. A wide variety of additional configuration changes are possible as will be appreciated.

At operation 708, the policy enforcement assistant 200 can be configured to identify and consolidate at least two overlapping configuration changes that were identified at operation 706. The policy enforcement assistant 200 can optionally increase the efficiency of implementing configuration changes by identifying and consolidating overlaps. Overlaps can be identified as identical configuration changes, or as configuration changes which effectively yield a same result, such as blocking a user or application from accessing a resource.

At operation 710, the policy enforcement assistant 200 can be configured to identify a respective implementation path for each respective network configuration change of the multiple configuration changes, as optionally consolidated at operation 708. Each respective implementation path can comprise a respective series of interactions with a respective network management tool 127, 128 to implement the respective configuration changes identified at operation 706.

Furthermore, at least two different implementation paths can use at least two different network management tools. For example, a first implementation path may use the network management tool 127, while a second implementation path may use the network management tool 128.

The at least two different network management tools can comprise, e.g., at least two of a network management tool to configure secure clients installed on endpoint devices of the network; a network management tool to configure user authentication functions of the network; a network management tool to configure one or more firewalls of the network; or a network management tool to configure Wi-Fi access points of the network. Of course, any network management tools may be used along with the policy enforcement assistant 200 described herein and this disclosure is not limited to any particular types of network management tools.

In an example implementation, identifying the multiple configuration changes at operation 706, consolidating overlapping configuration changes at operation 708, and identifying a respective implementation path for each respective network configuration change at operation 710, can comprise providing an intent indication 202 as an input to a trained machine learning model implemented via configuration change / implementation path determination engine 203.

At operation 712, the policy enforcement assistant 200 can be configured to generate an output 220 comprising the respective implementation path for each respective network configuration change, as identified via operations 706, 708, and 710. The output 220 can comprise an implementation path e.g., by including data describing the implementation path or by including automated operations to perform all or part of an implementation path.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
determining an intent indication corresponding to a configuration change intent in a network;
identifying, based on the intent indication, multiple configuration changes applicable to the network under a policy associated with the network;
identifying a respective implementation path for each respective network configuration change of the multiple configuration changes,
wherein the respective implementation path comprises a respective series of interactions with a respective network management tool to implement the respective network configuration change, and
wherein at least two different implementation paths use at least two different network management tools; and
generating an output comprising the respective implementation path for each respective network configuration change.

2. The method of claim 1, wherein the configuration change intent comprises a user change, a device change, a service change, or a security threat.

3. The method of claim 1, wherein determining the intent indication comprises receiving an input and using a large language model to determine the intent indication based on the input.

4. The method of claim 1, wherein identifying the multiple configuration changes and identifying the respective implementation path for each respective network configuration change comprises providing the intent indication as an input to a trained machine learning model.

5. The method of claim 1, wherein the multiple configuration changes comprise configuration changes to block or restrict a user of the network, configuration changes to block or restrict a device connected to the network, configuration changes to block or restrict a service of the network, or configuration changes to block or restrict a security threat of the network.

6. The method of claim 1, wherein the method is performed at least in part by a network policy enforcement assistant implemented within a combined network management console equipped with access to the at least two different network management tools.

7. The method of claim 1, wherein the at least two different network management tools comprise at least two of:
a network management tool to configure secure clients installed on endpoint devices of the network;
a network management tool to configure user authentication functions of the network;
a network management tool to configure one or more firewalls of the network; or
a network management tool to configure Wi-Fi access points of the network.

8. The method of claim 1, wherein identifying the multiple configuration changes comprises identifying and consolidating at least two overlapping configuration changes.

9. A device comprising:
one or more processors; and
one or more non-transitory computer-readable media storing computer-executable instructions that, when executed by the one or more processors, cause the one or more processors to perform operations comprising:
determining an intent indication corresponding to a configuration change intent in a network;
identifying, based on the intent indication, multiple configuration changes applicable to the network under a policy associated with the network;
identifying a respective implementation path for each respective network configuration change of the multiple configuration changes,
wherein the respective implementation path comprises a respective series of interactions with a respective network management tool to implement the respective network configuration change, and
wherein at least two different implementation paths use at least two different network management tools; and
generating an output comprising the respective implementation path for each respective network configuration change.

10. The device of claim 9, wherein the configuration change intent comprises a user change, a device change, a service change, or a security threat.

11. The device of claim 9, wherein determining the intent indication comprises receiving an input and using a large language model to determine the intent indication based on the input.

12. The device of claim 9, wherein identifying the multiple configuration changes and identifying the respective implementation path for each respective network configuration change comprises providing the intent indication as an input to a trained machine learning model.

13. The device of claim 9, wherein the multiple configuration changes comprise configuration changes to block or restrict a user of the network, configuration changes to block or restrict a device connected to the network, configuration changes to block or restrict a service of the network, or configuration changes to block or restrict a security threat of the network.

14. The device of claim 9, wherein the operations are performed at least in part by a policy enforcement assistant implemented within a combined network management console equipped with access to the at least two different network management tools.

15. The device of claim 9, wherein the at least two different network management tools comprise at least two of:
a network management tool to configure secure clients installed on endpoint devices of the network;
a network management tool to configure user authentication functions of the network;
a network management tool to configure one or more firewalls of the network; or
a network management tool to configure Wi-Fi access points of the network.

16. The device of claim 9, wherein identifying the multiple configuration changes comprises identifying and consolidating at least two overlapping configuration changes.

17. A method comprising:
determining an intent indication corresponding to configuration change intent in a network;
identifying, based on the intent indication, at least two configuration changes applicable to the network;
identifying respective implementation paths for each of the at least two configuration changes,
wherein the respective implementation paths comprise respective series of interactions with respective network management tools; and
generating an output comprising the respective implementation paths for each respective network configuration change.

18. The method of claim 17, wherein identifying the respective implementation paths for each of the at least two configuration changes comprises providing the intent indication as an input to a trained machine learning model.

19. The method of claim 17, wherein the output comprising the respective implementation paths for each respective network configuration change comprises:
instructions for a user to perform the respective series of interactions with the respective network management tools; or
automated interactions with the respective network management tools to perform the respective series of interactions.

20. The method of claim 17, wherein the method is performed at least in part by a policy enforcement assistant implemented within a combined network management console equipped with access to the respective network management tools.
